(19) United States
(12) Patent Application Publication
(10) Pub. No.: US 2023/0152595 A1
(43) Pub. Date: May 18, 2023

(54) FRAME BENDING COMPENSATION IN SMART GLASSES FOR IMMERSIVE REALITY APPLICATIONS

(71) Applicant: Meta Platforms Technologies, LLC, Menlo Park, CA (US)

(72) Inventors: Suhas Gupta, San Jose, CA (US); Sebastian Sztuk, Virum (DK); Igor Markovsky, Campbell, CA (US)

(21) Appl. No.: 17/946,853

(22) Filed: Sep. 16, 2022

Related U.S. Application Data
(60) Provisional application No. 63/280,525, filed on Nov. 17, 2021.
(60) Provisional application No. 63/309,375, filed on Feb. 11, 2022.

(51) Int. Cl. G02B 27/01

(52) U.S. Cl. CPC G02B 27/0176; G02B 27/0172; G02B 27/0179; G02B 2027/0178; G02B 2027/0138; G02B 2027/014

(57) ABSTRACT

A headset with frame bending compensation is provided. The headset includes a first eyepiece and a second eyepiece mounted on a frame, a display disposed between the first eyepiece and the second eyepiece, a projector optically coupled with the display, and a mechanical fixture configured to resiliently maintain an optical alignment between the display and the projector, wherein the first eyepiece and the second eyepiece include a partially transparent optical material to provide a direct reality image to a user, and the display provides a virtual image to the user. A method for adjusting the above headset for compensating a frame bending is also provided.

### CROSS-REFERENCE TO RELATED APPLICATIONS

The present disclosure is related and claims priority, under 35 USC § 119(e) to U.S. Prov. Appl. No. 63/280,525, entitled COMPENSATING FRAME BENDING USING STRAIN GAUGE SIGNAL TO MODIFY CONTENT, to Sebastian SZTUK, et-al., filed on Nov. 17, 2021, and to U.S. Prov. Appl. No. 63/309,375, entitled FRAME BENDING COMPENSATION IN SMART GLASSES FOR IMMERSIVE REALITY APPLICATIONS, to Suhas GUPTA, et-al., filed on Feb. 11, 2022, the contents of which applications are hereby incorporated by reference, for all purposes.

### BACKGROUND

### Field

The present disclosure is directed to compensation and adjustment of smart glass displays for adequate view in immersive reality applications. More specifically, embodiments as disclosed herein are directed to compensation and adjustment of smart glass displays for frame bending.

### Related Art

In the field of wearable devices, smart glasses offer a convenient, light weight, and small form factor appliance for augmented reality (AR) applications. Due to their lightness, the smart glass frames tend to flex or bend under stress. In fact, in some embodiments, the glass frame and even the eyepiece material is made to withstand a degree of flexing or bending and not break under light or medium stress, resiliently and seamlessly recovering their original shape. Moreover, and due to the low form factor of smart glasses, users may have a tendency to inadvertently drop the smart glasses while using them, or carrying them. However, in smart glasses configured for AR, active optical components may become misaligned or distorted during bending or drops, altering the quality of the display momentarily, or even permanently.

### SUMMARY

In a first embodiment, a headset includes a first eyepiece and a second eyepiece mounted on a frame, a display disposed between the first eyepiece and the second eyepiece, a projector optically coupled with the display, and a mechanical fixture configured to resiliently maintain an optical alignment between the display and the projector, wherein the first eyepiece and the second eyepiece include a partially transparent optical material to provide a direct reality image to a user, and the display provides a virtual image to the user.

In a second embodiment, a storage case for storing a headset includes a cavity configured to receive the headset. The headset including a first eyepiece and a second eyepiece mounted on a frame, a display disposed between the first eyepiece and the second eyepiece, a projector optically coupled with the display, and a mechanical fixture configured to resiliently maintain an optical alignment between the display and the projector, wherein the first eyepiece and the second eyepiece include a partially transparent optical material to provide a direct reality image to a user, and the display provides a virtual image to the user. The storage case also includes an optical device configured to measure the optical alignment between the display and the projector.

In a third embodiment, a method as provided includes receiving a signal indicative of an optical alignment between a display and a projector in a headset, determining a size or shape distortion in the optical alignment based on the signal, and adjusting the projector and the display based on the size or shape distortion.

In yet other embodiments, a system includes a memory storing instructions which, when executed by one or more processors, cause the system to perform operations. The operations include to receive a signal indicative of an optical alignment between a display and a projector in a headset, to determine a size or shape distortion in the optical alignment based on the signal, and to adjust the projector and the display based on the size or shape distortion.

In a further embodiment, a system includes a first means to store instructions and a second means to execute the instructions and cause the system to perform a method. The method includes receiving a signal indicative of an optical alignment between a display and a projector in a headset, determining a size or shape distortion in the optical alignment based on the signal, and adjusting the projector and the display based on the size or shape distortion.

These and other embodiments will become clear as per the following disclosure.

### BRIEF DESCRIPTION OF THE DRAWINGS

FIG. 1 illustrates an architecture including a smart glass coupled to a mobile device, a remote server and to a database, according to some embodiments.

FIGS. 2A-2F illustrate multiple cross-sectional views of a smart glass with a display mechanically coupled with a projector, between front and rear eyepieces and a frame, according to some embodiments.

FIG. 3 illustrates a smart glass including a camera or sensor for active alignment of the projector and the display, according to some embodiments.

FIG. 4 illustrates a case to store a smart glass, including a camera and a photodiode disposed such that a shape or size distortion in the device or within different components of the device may be identified, according to some embodiments.

FIG. 5 is a flow chart illustrating steps in a method for adjusting a display in a headset to compensate for bending and other stresses, according to some embodiments.

FIG. 6 illustrates a system configured to execute at least partially one or more of the processes in FIG. 5.

In the figures, elements having the same or similar reference numeral have the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

Smart glasses for AR applications are expected to undergo numerous stress exertions during use, transportation, or even storage (e.g., inside a car/vehicle glove compartment, suitcase, and the like). Smart glasses as disclosed herein may include monocular display devices, in which the display for augmented reality applications is located in one of the two eyepieces, or a binocular display, in which one or more displays for augmented reality applications are located on each of the eyepieces. In a binocular display, the two or more displays may generate a stereo image overlap, creating a three-dimensional (3D) impression to the user (e.g., depth perception). As a consequence, and given the resilient fabrication materials typically used for the frames and structures of smart glasses, it is expected that the active optical components therein will undergo a degree of displacement and even misalignment. Be it temporary or permanent, however gradual, but progressive, such misalignment may affect the quality of the image in the smart glass display. Misalignment and bending of the smart glass frame may also cause unwanted virtual image displacement in a monocular display, or a loss of synchronization in a stereo image overlap for binocular displays. In addition to causing an immediate inconvenience to the user (e.g., eye strain and/or loss of depth perception), this may in fact permanently disable the device if not corrected in time.

To resolve the above challenge, the present disclosure provides embodiments of smart glasses that can adjust in real time to even minor bends, reshapes, or alterations in the configuration of the frame caused by typical stresses and other bending forces to which these devices are subjected to, during use, transportation, and storage.

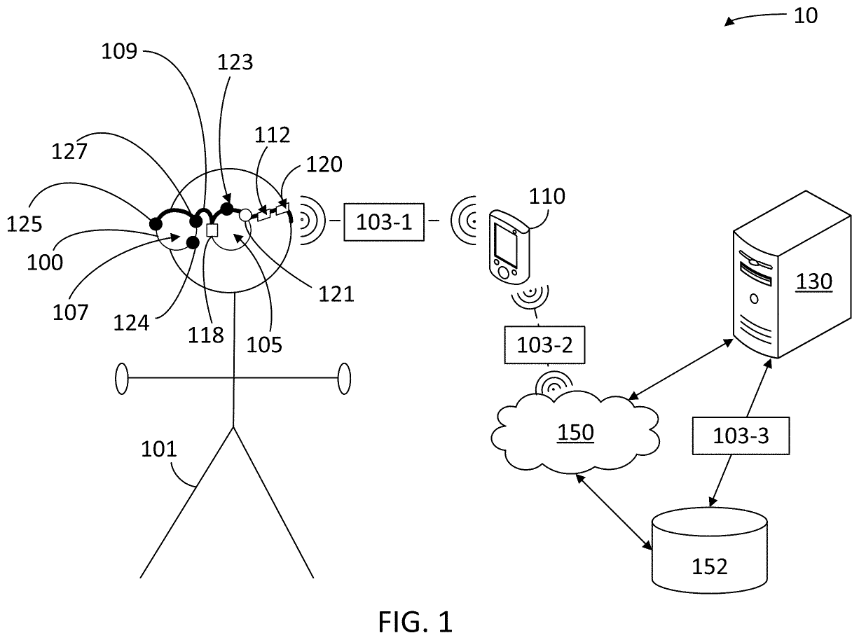

FIG. 1 illustrates an architecture 10 including a smart glass 100 coupled to a mobile device 110, a remote server 130, and to a database 152 via a network 150, according to some embodiments. Smart glass 100 is configured for AR applications, and mobile device 110 may be a smart phone, all of which may communicate with one another via wireless communications and exchange a first dataset (e.g., “Dataset 103-1”). Dataset 103-1 may include a recorded video, audio, or some other file or streaming media. A user 101 of smart glass 100 is also the owner of, or is associated with, mobile device 110. In some embodiments, smart glass 100 may directly communicate with remote server 130, database 152, or any other client device 110 (e.g., a smart phone of a different user, and the like) via network 150. Mobile device 110 may be communicatively coupled with remote server 130 and database 152 via network 150, and transmit/share information, files, and the like with one another (e.g., dataset 103-2 and dataset 103-3).

In some embodiments, smart glass 100 includes two eyepieces 105 and at least one projector 127 and a display 107 to show a computer-generated image to user 101, in one or both eyepieces. In a monocular embodiment, only one display 107 is disposed in either one of eyepieces 105. In a binocular embodiment, at least one display 107 is placed on each of eyepieces 105 (e.g., two displays 107 sharing one projector 127, or having a dedicated projector each). For a binocular display, the virtual images provided by each display 107 may be spatially and/or temporally synchronized to provide a 3D view to user 101. Smart glass 100 may include inertial measurement unit (IMU) sensors 123, microphones, camera 121, stress sensors 124, and shape/size/displacement sensors 125 mounted on a frame 109.

In addition, smart glass 100, and any other wearable device, or mobile device 110 may include a memory circuit 120 storing instructions, and a processor circuit 112 configured to execute the instructions to cause smart glass 100 to perform, at least partially, some of the steps in methods consistent with the present disclosure. In some embodiments, smart glass 100, mobile device 110, server 130, and/or database 152 may further include a communications module 118 enabling the device to wirelessly communicate with remote server 130 via network 150. Smart glass 100 may thus download a multimedia online content (e.g., dataset 103-1) from remote server 130, to perform at least partially some of the operations in methods as disclosed herein. In some embodiments, memory 120 may include instructions to cause processor 112 to receive and combine signals from inertial measurement unit (IMU) sensors 123, microphones, camera 121, stress sensors 124, and shape/size/displacement sensors 125 to identify device drops, bending, shape, and size distortion of frame 109.

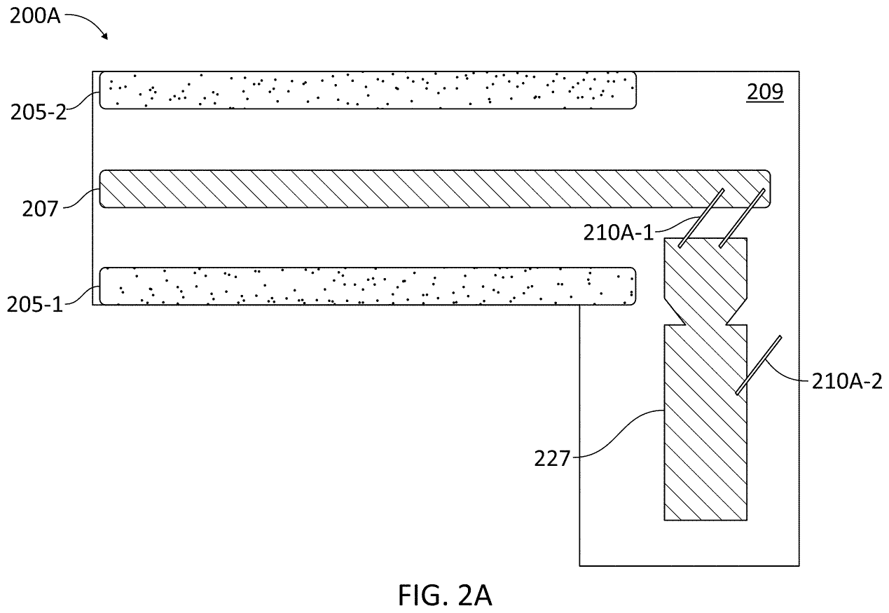

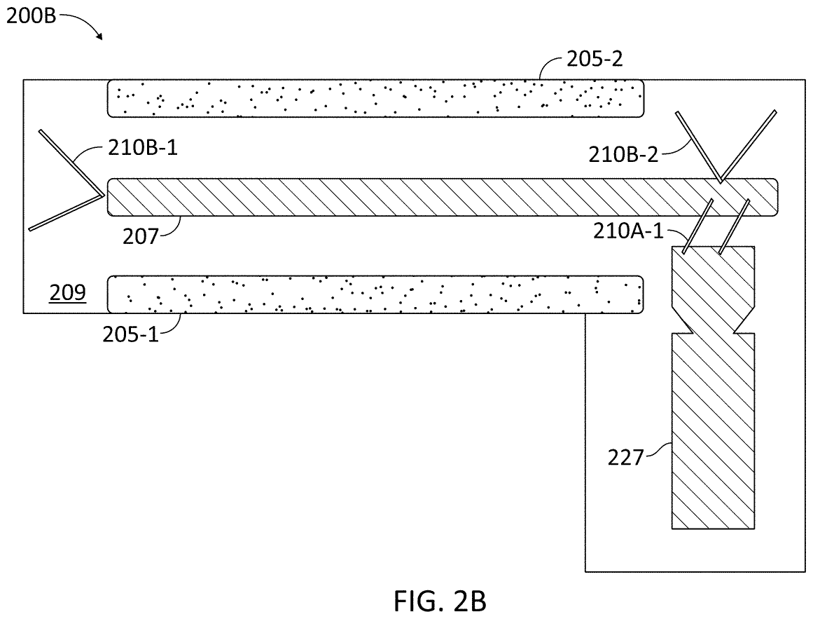

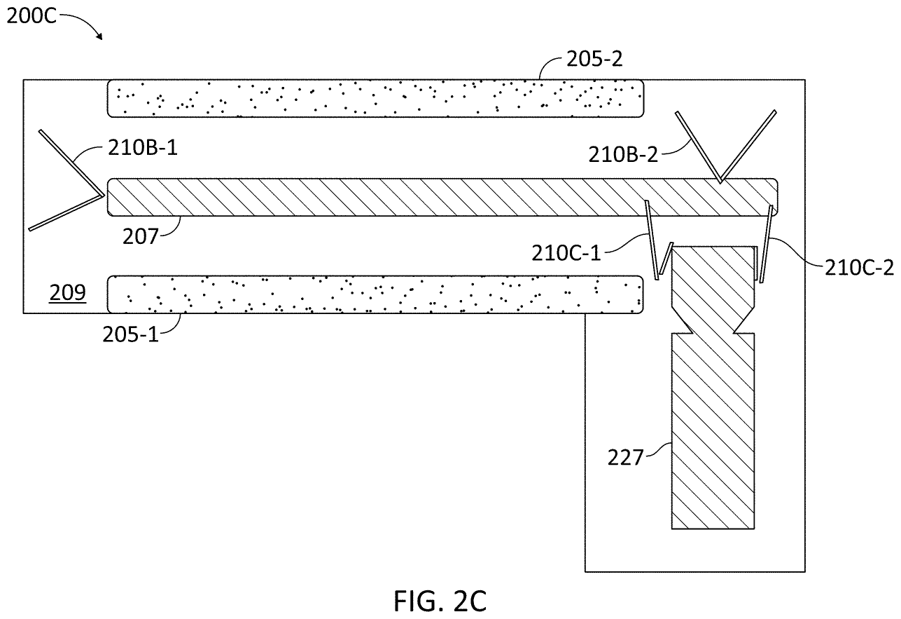

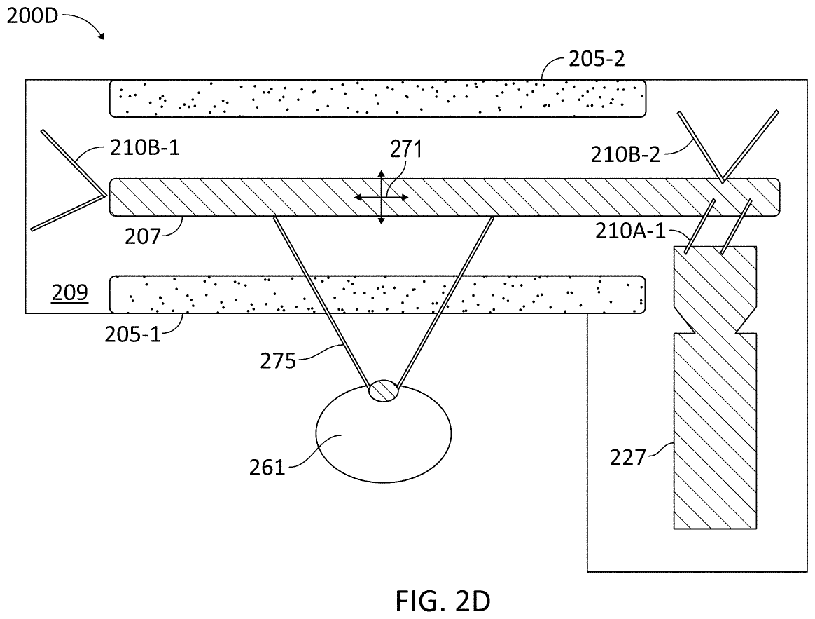

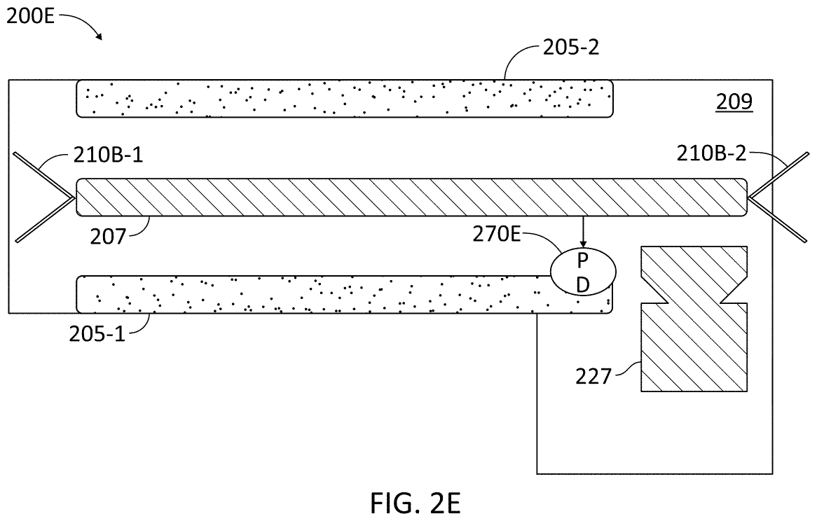

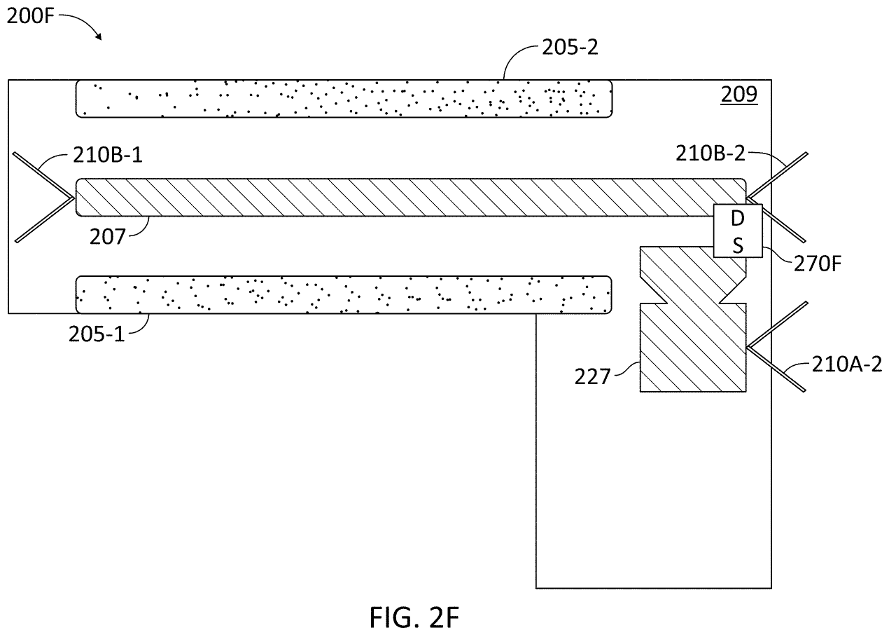

FIGS. 2A-2F illustrate multiple cross-sectional views 200A, 200B, 200C, 200D, 200E, and 200F (hereinafter, collectively referred to as “cross-sectional views 200”) of a smart glass 100 with a display 207 mechanically coupled with a projector 227, between front 205-2 and rear 205-1 eyepieces (hereinafter, collectively referred to as “eyepieces 205”) and a frame 209, according to some embodiments. Links 210A-1, 210A-2, 210B-1 and 210B-2, 210C-1 and 210C-2 (hereinafter, collectively referred to as “links 210”), are disposed for mechanically coupling each of display 207, eyepieces 205, projector 227, and frame 209. In some embodiments, links 210 may include a glue or viscoelastic material, a solid piece such as a screw or bolt, or clip, or a spring-loaded element, to provide soft and resilient mechanical coupling.

Cross-sectional view 200A includes a display mechanically coupled to projector 227 via link 210A-1 and allowed to move freely between front and rear eyepieces and the frame, according to some embodiments. Projector 227 may in turn be mechanically coupled to frame 209 via link 210A-2. Links 210A-1 and 210A-2 (hereinafter, collectively referred to as “links 210A”) may include a glue or viscoelastic material, or a spring-loaded pin, or a bolt and screw, or clip, and the like.

Cross-sectional view 200B includes display 207 mechanically coupled to projector 227 via link 210A-1 and to frame 209 via links 210B-1 and 210B-2 (hereinafter, collectively referred to as “links 210B”), and allowed to move freely between front and rear eyepieces 205, according to some embodiments. This embodiment enables display 207 and projector 227 assembly to translate in unison during a bending event and shows robust performance against drops and thermal stress as these translate the display/projector assembly. In a monocular design (e.g., display 207 is only included in one of eyepieces 105 of smart glass 100), even the misalignment will only move an eyebox within display 207 (the eyebox is an area of space wherein the user's pupil is expected to move). A displacement of the eyebox may be corrected via software stored in memory and run by a processor (e.g., memory 120 and processor 112).

Cross-sectional view 200C illustrates a-thermalized projector links 210C-1 and 210C-2 (hereinafter, collectively referred to as “links 210C”) to display 207 to ensure that thermal stress and/or drop do not impact the position of projector 227 relative to display 207 and frame 209.

Cross sectional view 200D illustrates an embodiment wherein the user can visualize (cf. user's eye 261) the relative positions of display 207, projector 227, and front/rear eyepieces 205 using fiduciary marks 271 indicative of misalignments and distortions via field of view 275, according to some embodiments. The user may adjust offsets manually, or via electronic controls actuated via a GUI on display 207.

Cross sectional view 200E illustrates a smart glass including a photodiode 270E that is correlated to measure a shape or size distortion in the image projected on display 207, according to some embodiments. Photodiode 270E may include a multi-cell photodiode 270E configured to identify image quality (e.g., focusing, sharpness, ghosting, and the like), or another metric (e.g., astigmatism, size, intensity, color range, and cropping). For example, a brightness reduction in one or more of the cells in photodiode 270E may be indicative of an angular or planar shift or misalignment of projector 227 and display 207.

Cross sectional view 200F illustrates a smart glass including a displacement sensor 270F to measure up to five highly sensitive degrees of freedom (DOFs) to identify shape and size distortion within the device, according to some embodiments. In some embodiments, at least one or more of the DOFs may be highly sensitive to a particular stress, torsion, or force exerted on the smart glass. Accordingly, displacement sensor 270F may be configured to measure the one or more DOFs that has the most sensitivity. In some embodiments, displacement sensor 270F may include a strain gauge, a capacitive sensor, an inductive sensor, or a fiber optic strain sensor.

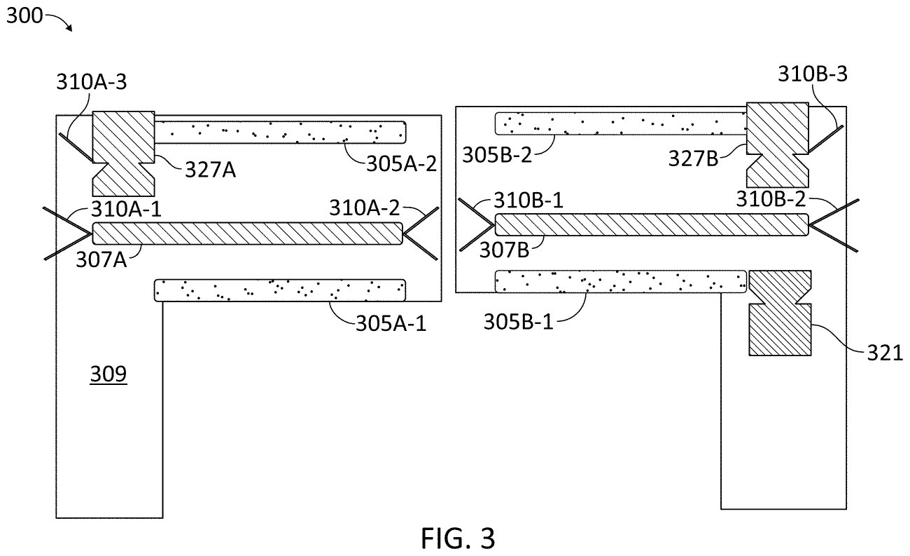

FIG. 3 illustrates a smart glass 300 including a camera 321 or sensor for active alignment of projectors 327A and 327B (hereinafter, collectively referred to as “projectors 327”) and displays 307A and 307B (hereinafter, collectively referred to as “displays 307”), according to some embodiments. Smart glass 300 is a binocular headset having mirroring configurations for both left and right eyes of the user. The binocular headset includes left (and right) front 305A-2 (305B-2) and rear 305A-1 (305B-1) eyepieces (hereinafter, collectively referred to as “eyepieces 305”)

Links 310A-1 and 310A-2 mechanically couple display 307A with frame 309. Link 310A-3 mechanically couples projector 327A to frame 309. Links 310B-1 and 310B-2 mechanically couple display 307B with frame 309. And link 310B-3 mechanically couples projector 327B to frame 309. Links 310A-1, 310A-2, and 310A-3, hereinafter, will be collectively referred to as “links 310A.” Links 310B-1, 310B-2, and 310B-3, hereinafter, will be collectively referred to as “links 310B.”

In some embodiments, camera 321 may compare a current capture of displays 307 with reference images stored in the memory (or provided by the server from the database, via the network, cf. memory 120, server 130, database 152 and network 150).

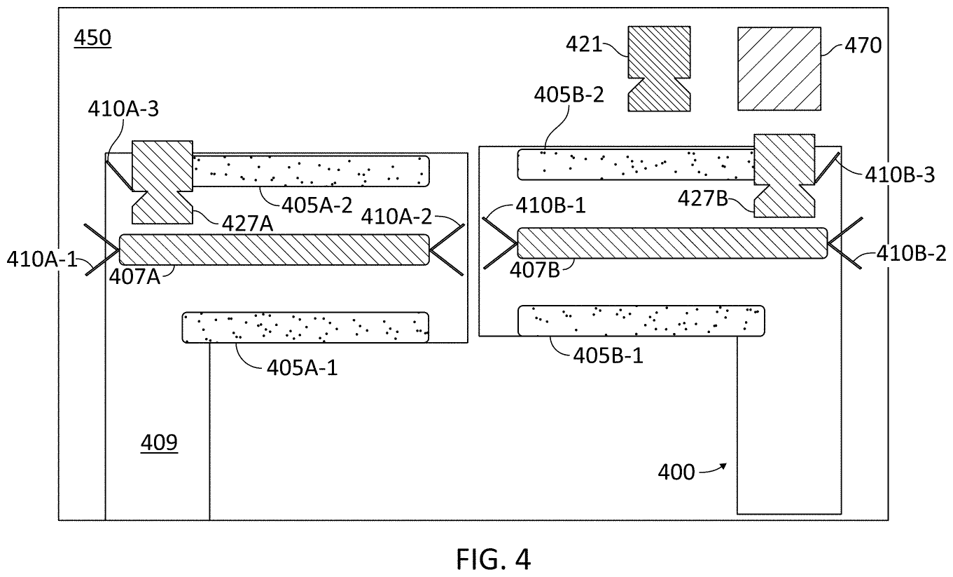

FIG. 4 illustrates a case 450 to store a smart glass 400, including a camera 421 and a photodiode 470 disposed such that a shape or size distortion in the device or within different components of the device may be identified, according to some embodiments. Smart glass 400 is a binocular headset including mirroring eyepieces 405A-1 and 405A-2, display 407A, and projector 427A for the user's left eye, with eyepieces 405B-1 and 405B-2, display 407B, and projector 427B for the user's right eye.

Links 410A-1 and 410A-2 mechanically couple display 407A with frame 409. Link 410A-3 mechanically couples projector 427A to frame 409. Links 410B-1 and 410B-2 mechanically couple display 407B with frame 409. And link 410B-3 mechanically couples projector 427B to frame 409. Links 410A-1, 410A-2, and 410A-3, hereinafter, will be collectively referred to as “links 410A.” Links 410B-1, 410B-2, and 410B-3, hereinafter, will be collectively referred to as “links 410B.”

Measurements from camera 421 and photodiode 470 are based on optical power, calibration image, and the like.

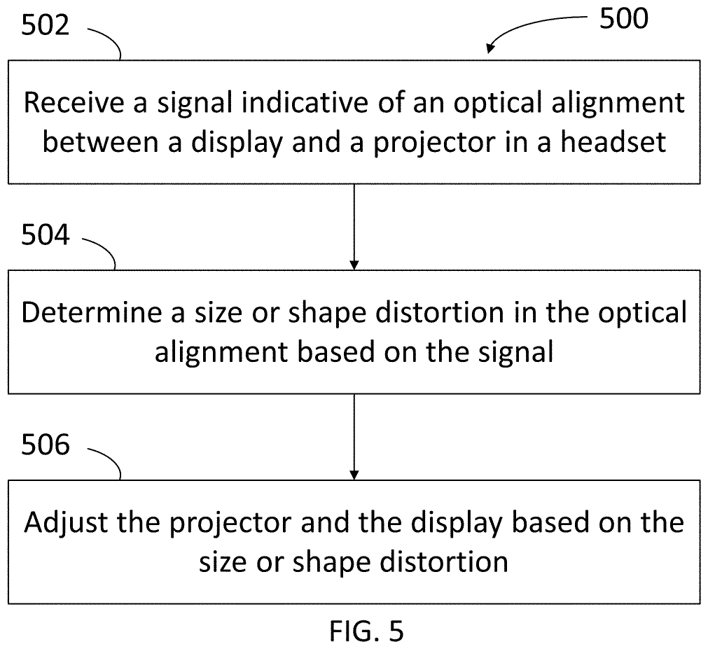

FIG. 5 is a flowchart illustrating steps in a method 500 for adjusting the optical alignment in a headset for augmented reality applications, according to some embodiments. In some embodiments, at least one or more of the steps in method 500 may be performed by a processor executing instructions stored in a memory in either one of a smart glass or other wearable device on a user's body part (e.g., head, arm, wrist, leg, ankle, finger, toe, knee, shoulder, chest, back, and the like). In some embodiments, at least one or more of the steps in method 500 may be performed by a processor executing instructions stored in a memory, wherein either the processor or the memory, or both, are part of a mobile device for the user, a remote server or a database, communicatively coupled with each other via a network. Moreover, the mobile device, the smart glass, and the wearable devices may be communicatively coupled with each other via a wireless communication system and protocol (e.g., radio, Wi-Fi, Bluetooth, near-field communication—NFC—and the like). In some embodiments, a method consistent with the present disclosure may include one or more steps from method 500 performed in any order, simultaneously, quasi-simultaneously, or overlapping in time. Accordingly, the headset may include a first eyepiece and a second eyepiece mounted on a frame, a display disposed between the first eyepiece and the second eyepiece, a projector optically coupled with the display, and a mechanical fixture configured to resiliently maintain an optical alignment between the display and the projector. The first eyepiece and the second eyepiece include a partially transparent optical material to provide a direct reality image to a user, and the display provides a virtual image to the user.

Step 502 includes receiving a signal indicative of an optical alignment between a display and a projector in a headset. In some embodiments, step 502 includes receiving the signal from an alignment setup in a charging case, during a charge event of the headset. In some embodiments, step 502 includes collecting, with a camera, an image of the display and the projector to measure the optical alignment between the display and the projector, wherein the image of the display and the projector includes at least a fiduciary mark to indicate a size or shape deformation of the optical alignment between the display and the projector. In some embodiments, step 502 includes receiving from a stress sensor in the headset, a signal indicative of a deformative stress on a headset frame. In some embodiments, step 502 includes receiving the signal from a displacement sensor disposed between the display and the projector.

Step 504 includes determining a size or shape distortion in the optical alignment based on the signal.

Step 506 includes adjusting the projector and the display based on the size or shape distortion. In some embodiments, step 506 includes directing at least a portion of a virtual image to a pupil of a headset user. In some embodiments, step 506 includes comparing the signal with a size and shape of the optical alignment between the display and projector from a reference image stored in a memory of the headset.

### Hardware Overview

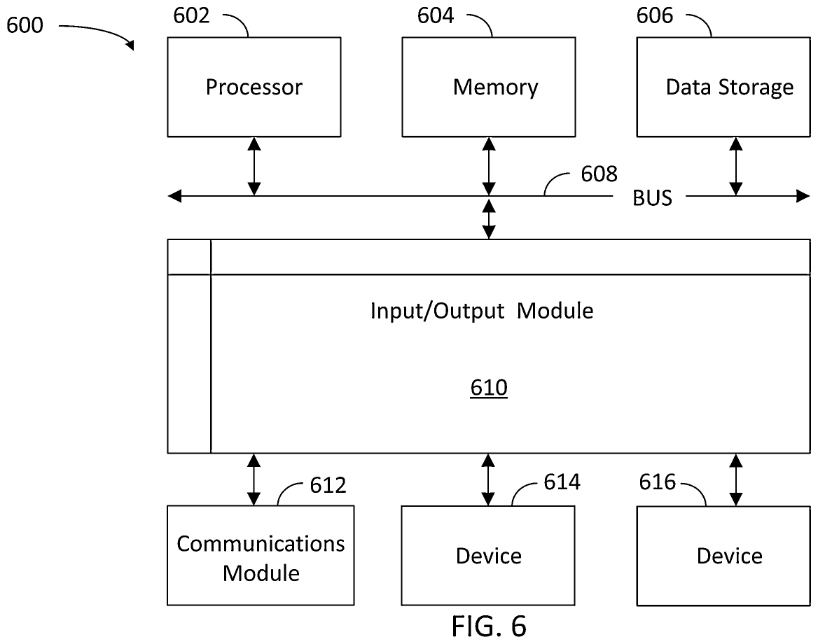

FIG. 6 is a block diagram illustrating an exemplary computer system 600 with which the client device 110 and server 130 of FIG. 1, and the methods of FIG. 5 can be implemented. In certain aspects, the computer system 600 may be implemented using hardware or a combination of software and hardware, either in a dedicated server, or integrated into another entity, or distributed across multiple entities.

Computer system 600 (e.g., client device 110 and server 130) includes a bus 608 or other communication mechanism for communicating information, and a processor 602 (e.g., processor 112) coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., memory 120), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, e.g., one or more modules of computer program instructions encoded on a computer-readable medium for execution by, or to control the operation of, the computer system 600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and intercoupled by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled with bus 608 for storing information and instructions. Computer system 600 may be coupled via input/output module 610 to various devices. Input/output module 610 can be any input/output module. Exemplary input/output modules 610 include data ports such as USB ports. The input/output module 610 is configured to connect to a communications module 612. Exemplary communications modules 612 (e.g., communications module 118) include networking interface cards, such as Ethernet cards and modems. In certain aspects, input/output module 610 is configured to connect to a plurality of devices, such as an input device 614 and/or an output device 616. Exemplary input devices 614 include a keyboard and a pointing device, e.g., a mouse or a trackball, by which a consumer can provide input to the computer system 600. Other kinds of input devices 614 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 616 include display devices, such as an LCD (liquid crystal display) monitor, for displaying information to the consumer.

According to one aspect of the present disclosure, the client device 110 and server 130 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

The subject technology is illustrated, for example, according to various aspects described below. Various examples of aspects of the subject technology are described as numbered claims (claim 1, 2, etc.) for convenience. These are provided as examples, and do not limit the subject technology.

In one aspect, a method may be an operation, an instruction, or a function and vice versa. In one aspect, a clause may be amended to include some or all of the words (e.g., instructions, operations, functions, or components) recited in other one or more clauses, one or more words, one or more sentences, one or more phrases, one or more paragraphs, and/or one or more clauses.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A device, comprising:
a first eyepiece and a second eyepiece mounted on a frame;
a display disposed between the first eyepiece and the second eyepiece;
a projector optically coupled with the display; and
a mechanical fixture configured to resiliently maintain an optical alignment between the display and the projector, wherein the first eyepiece and the second eyepiece include a partially transparent optical material to provide a direct reality image to a user, and the display provides a virtual image to the user.

2. The device of claim 1, further comprising an optical sensor configured to measure the optical alignment between the display and the projector.

3. The device of claim 1, wherein the mechanical fixture is thermalized to maintain the optical alignment over a temperature range spanning at least 40° Celsius.

4. The device of claim 1, further comprising a camera configured to collect an image of the display and the projector to measure the optical alignment between the display and the projector, wherein the image of the display and the projector includes at least a fiduciary mark to indicate a size or shape deformation of the optical alignment between the display and the projector.

5. The device of claim 1, further comprising a stress sensor configured to provide a signal indicative of a deformative stress on the frame, and a processor circuit configured to execute instructions to correct the optical alignment between the display and the projector when the signal is larger than a pre-selected threshold.

6. The device of claim 1, further comprising a displacement sensor configured to identify a size or shape distortion of the optical alignment between the display and the projector.

7. The device of claim 1, wherein the mechanical fixture mechanically couples the display and the projector to the frame.

8. The device of claim 1, further comprising a memory storing multiple instructions and a processor configured to execute the instructions to adjust the optical alignment between the display and the projector to direct at least a portion of the virtual image to a pupil of the user.

9. The device of claim 1, further comprising a memory storing multiple instructions and a reference image, and a processor configured to execute the instructions to adjust the optical alignment between the display and the projector based on the reference image.

10. The device of claim 1, wherein the first eyepiece and the second eyepiece are extended to overlap two eyes in a user's face.

11. A storage case for storing a device, comprising:
a cavity configured to receive the device, the device including:
a first eyepiece and a second eyepiece mounted on a frame;
a display disposed between the first eyepiece and the second eyepiece;
a projector optically coupled with the display; and
a mechanical fixture configured to resiliently maintain an optical alignment between the display and the projector, wherein the first eyepiece and the second eyepiece include a partially transparent optical material to provide a direct reality image to a user, and the display provides a virtual image to the user; and
an optical device configured to measure the optical alignment between the display and the projector.

12. The storage case of claim 11, wherein the optical device includes a multi-cell photodiode.

13. The storage case of claim 11, wherein the optical device is a camera configured to collect an image of the display and the projector.

14. The storage case of claim 11, further comprising a communications module configured to provide, to a memory in the device, a parameter setting to adjust the optical alignment between the display and the projector when a distortion is detected.

15. A method, comprising:
receiving a signal indicative of an optical alignment between a display and a projector in a headset;
determining a size or shape distortion in the optical alignment based on the signal; and
adjusting the projector and the display based on the size or shape distortion.

16. The method of claim 15, wherein receiving a signal indicative of an optical alignment comprises collecting, with a camera, an image of the display and the projector to measure the optical alignment between the display and the projector, wherein the image of the display and the projector includes at least a fiduciary mark to indicate a size or shape deformation of the optical alignment between the display and the projector.

17. The method of claim 15, wherein receiving a signal indicative of an optical alignment comprises receiving, from a stress sensor in the headset, a signal indicative of a deformative stress on a headset frame.

18. The method of claim 15, wherein receiving a signal indicative of an optical alignment comprises receiving the signal from a displacement sensor disposed between the display and the projector.

19. The method of claim 15, wherein adjusting the projector and the display based on the size or shape distortion comprises directing at least a portion of a virtual image to a pupil of a headset user.

20. The method of claim 15, wherein adjusting the projector and the display based on the size or shape distortion comprises comparing the signal with a size and shape of the optical alignment between the display and projector from a reference image stored in a memory of the headset.
